(19) United States
(12) Patent Application Publication
(10) Pub. No.: US 2014/0325904 A1
(43) Pub. Date: Nov. 6, 2014

(54) PLYWOOD GARDEN CONTAINER

(71) Applicant: Glen D. Brown, Willits, CA (US)

(72) Inventor: Glen D. Brown, Willits, CA (US)

(21) Appl. No.: 13/875,134

(22) Filed: May 1, 2013

(51) Int. Cl. A01G 9/02

(52) U.S. Cl. CPC A01G 9/02
USPC 47/65.5

(57) ABSTRACT

The instant invention provides a plywood garden container that is inexpensive to manufacture, that may be produced sustainably, that is lightweight, that is durable, that is not prone to bowing of straight sides, that preserves the shape of curved sides, that is not prone to aliasing during handling, and that may be of any desired shape. A plywood garden container includes plywood boards (sides) to form an outer structure. Lightweight posts or hinges are disposed at each corner of the structure to hold sides upright and to enclose a plywood garden container. Wooden parts of a plywood garden container are painted with a food-grade paint before assembly in order to seal the wood. A sheet of wire mesh is pulled taught across an underside of the structure and secured with anchors. A plywood garden container includes an open top. After a garden is planted in a plywood garden container, the wire mesh distributes pressure away from the corners and to all parts of the container. A novel use for food-grade paint extends the useful life of the instant invention.

### CROSS REFERENCES TO RELATED APPLICATIONS

Not applicable. The present application is an original and first-filed United States Utility Patent Application.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention generally relates to containers used to plant gardens and more particularly, to a plywood structure suitable for planting a garden.

2. Background Discussion

Home gardens have many benefits. Gardens can provide a significant portion of a person's caloric intake as well as providing specific nutrients that may be difficult or expensive to obtain otherwise. A home gardener can ensure that their food does not contain harmful herbicides or pesticides, and food may be grown organically. Food picked and eaten fresh from a garden provides more nutrition than food purchased from a grocery store and often tastes better than store-bought food. Gardens can improve the appearance and value of a home. Gardening can provide stress relief and enjoyment. Finally, home gardens may be used to teach children about farming and about the life cycles of plants and animals.

In general gardens may be placed directly in the ground. However, at times it may be necessary to use a container for gardening, for example if adequate ground to grow a garden is unavailable or if existing ground has been contaminated by household or industrial waste. A garden container provides a gardening space that may be used either indoors or outdoors. With planning for proper drainage, a garden container can also be used on a patio, porch or even a rooftop. Gardening inside of a container has advantages compared to growing a garden directly in the ground. Garden containers may be filled with growing media best suited for what will be planted in the garden container. Garden containers offer a gardener more control over the chemical environment in the garden. Garden containers are useful to those who enjoy gardening but suffer from back pain or injury. Because a garden container can raise the gardening surface by as much as two feet, garden containers can significantly reduce the amount of bending of the back necessary for gardening. Finally, containers used for gardening can be more easily reinforced against pests such as burrowing animals than can gardens grown directly in the ground.

Prior art garden containers, typically made from plastic or thick hardwood planks, have many disadvantages. Plastic may be prone to cracking or breakage over time. Durable plastics fashioned to the size of a typical outdoor garden container would be expensive and too heavy to move or carry. Prior art plastic garden containers tend to be small and only used under controlled conditions, for example indoor gardening.

Milled hardwood planks typically used in garden containers are already in high demand by the economy. Hardwoods in particular have not been harvested sustainably in the past. Most of the world's old growth forests have already been harvested. Increasing demand for wooden garden containers may result in still more unsustainable harvesting of our forests.

Garden containers made from hardwood planks are prone to rot due to the mold and bacteria that live on the wood. A combination of rot at the corners where boards comprising the sides of the garden container are fastened together and the pressure exerted by dirt and water along the sides of the container eventually cause prior art garden containers to fail. Thus, many prior art garden containers use heavy corner posts, metal braces, metal spikes, or other devices to reinforce the corners of the container. Reinforcing the corners of the garden container in this manner adds even more weight and expense to the garden container. Rotting wood in an aging garden container made from hardwood planks introduces unwanted bacteria into the soil used to fill the container. When bacteria from rotting wood competes with beneficial bacteria for nutrients in the soil, the health of plants in the garden container may be negatively affected. Hardwood planks used to fashion prior art garden containers also provide a reservoir for excess water, which makes adjusting the pH or nutrient levels in the container more difficult. Excess water contained in the hardwood planks also contributes to the problem of rot as described above.

Paint can be an especially good way to prevent wood from rotting, which may be especially important for garden containers made from thin boards. However, prior art garden containers typically are not painted as toxic chemicals may enter the soil contained in the garden container. Although food-grade paint has been used commonly in industries where food is processed including farming, applications where paint does not make direct contact with food are not known.

Prior art garden containers may be expensive compared to other items necessary for gardening, for example dirt, seeds, and organic fertilizer.

Prior art garden containers typically come in fixed shapes or modules and typically do not include curved sides.

Prior art wooden garden containers made from hardwood planks typically are too heavy for an average person to pick up or carry.

Prior art garden containers are typically prone to another type of damage due to stress at corners, hereinafter called “aliasing,” that occurs with normal shipping and handling of the empty garden container. Aliasing occurs when opposing sides of a wooden garden container slide in opposite directions with respect to the parallel lines making up their bottom edges. The heavy weight of the hardwood planks used in prior art garden containers contributed to rather than helped to solve the aliasing problem.

Plywood is generally not used for garden containers even though it is the strongest and most sustainably produced wood available. Plywood is stronger than other wood because it is fashioned such that it has a grain running in two orthogonal directions. Plywood may be produced more sustainably than hardwood planks because plywood is fashioned from very young trees while hardwood planks are fashioned from mature trees.

The pliable nature of plywood makes plywood prone to bending (or bowing) and therefore not suitable for garden containers according to prior art. The pressure exerted by the dirt and water placed in the garden container, or bowing pressure, would cause plywood garden containers to fail shortly after being put into use according to prior art. Adding a wooden frame to support the plywood or using thick plywood would reintroduce all of the problems associated with garden containers made from hardwood planks discussed above including sustainability, expense, weight, bacterial growth, and hard to reach water.

Thus, there exists today a need for a garden container that helps to ameliorate the above-mentioned problems and difficulties as well as ameliorate those additional problems and difficulties as may be recited in the “OBJECTS AND SUMMARY OF THE INVENTION” or discussed elsewhere in the specification or which may otherwise exist or occur and that are not specifically mentioned herein.

As various embodiments of the instant invention help provide a more elegant solution to the various problems and difficulties as mentioned herein, or which may otherwise exist or occur and are not specifically mentioned herein, and by a showing that a similar benefit is not available by mere reliance upon the teachings of relevant prior art, the instant invention attests to its novelty. Therefore, by helping to provide a more elegant solution to various needs, some of which may be long-standing in nature, the instant invention further attests that the elements thereof, in combination as claimed, cannot be obvious in light of the teachings of the prior art to a person of ordinary skill and creativity.

Clearly, such an apparatus would be useful and desirable.

Garden containers are well known. For example, the following patent documents describe various types of these devices, some of which may have some degree of relevance to the invention. Other patent documents listed below may not have any significant relevance to the invention. The inclusion of these patent documents is not an admission that their teachings anticipate any aspect of the invention. Rather, their inclusion is intended to present a broad and diversified understanding regarding the current state of the art appertaining to either the field of the invention or possibly to other related or even distal fields of invention.

### DESCRIPTION OF PRIOR ART

U.S. Pat. No. 7,533,491 to Singer, et al., which issued on May 19, 2009:

U.S. Pat. No. 7,490,435 to Singer, which issued on Feb. 17, 2009; U.S. Pat. No. 7,424,787 to Singer, which issued on Sep. 16, 2008; U.S. Pat. No. 6,434,882 to Becker, which issued on Aug. 20, 2002; and U.S. Pat. No. 4,897,955 to Winsor, which issued on Feb. 6, 1990.

While the structural arrangements of the above described devices may, at first appearance, have similarities with the present invention, they differ in material respects. These differences, which will be described in more detail hereinafter, are essential for the effective use of the invention and which admit of the advantages that are not available with the prior devices.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

It is a first and principal object of the present invention to provide a container to be used for gardening that is made of thin, untreated plywood, and thus referred to herein as a “plywood garden container.”

Another object of the invention is to provide a plywood garden container that is made of thin boards made of raw wood.

Another important object of the invention is to provide a plywood garden container that includes a chicken wire mesh anchored proximate the bottom, on all sides, and at a multiplicity of anchor points.

Yet another object of the invention is to provide a plywood garden container that includes hardware cloth anchored on all sides and at a multiplicity of anchor points proximate the bottom of the plywood garden container.

A further object of the invention is to provide a plywood garden container that prevents bowing of straight sides.

A still further object of the invention is to provide a plywood garden container that preserves bowing of curved sides.

Another important object of the invention is to provide a plywood garden container that resists aliasing.

Still yet another object of the invention is to provide a plywood garden container with 90 degree angles between sides and with corners fashioned from lightweight corner posts.

Still yet another object of the invention is to provide a plywood garden container of any desired shape with corners fashioned from hinges.

A further object of the invention is to provide a plywood garden container that helps prohibit entry of gophers and other burrowing animals.

Still yet another important object of the invention is to provide an improvement to a wooden garden container specifically the instant plywood garden container by sealing the wood used in fashioning the container with a food-grade paint.

A first continuing object of the invention is to provide a plywood garden container made from ecologically friendly materials.

A second continuing object of the invention is to provide a plywood garden container that helps control the amount of bacteria that is present within the garden bed.

A third continuing object of the invention is to provide a plywood garden container that helps control the chemical environment within the garden bed.

A fourth continuing object of the invention is to provide a plywood garden container that is lightweight.

A fifth continuing object of the invention is to provide a plywood garden container that is inexpensive to manufacture.

A sixth continuing object of the invention is to provide a plywood garden container that includes a rectangular shape, a hexagon, or a curved shape in appearance.

A seventh continuing object of the invention is to provide a plywood garden container that includes any desired shape in appearance.

Briefly, a garden container that is constructed in accordance with the principles of the present invention includes one or more three-eighths inch thick plywood sides that form an outer structure for the plywood garden container. Each plywood side of a plywood garden container is preferably made from untreated plywood. Alternatively each side of a plywood garden container may be made from thin, e.g. one half inch, pieces of raw lumber. The sides of a plywood garden container may be straight or curved in appearance, as desired.

A food-grade paint is used to seal sides and wooden corner posts (if desired) to be used in the fabrication of the plywood garden container. Painting with food-grade paint provides a safe and novel way to extend the useful life and improve the aesthetics of a plywood garden container. Painting a plywood garden container also protects wood from rotting and gives gardeners more control over the growing environment when the container is eventually used for gardening.

A rectangular embodiment with four straight plywood sides and lightweight corner posts is first described. The dimensions of a preferred square or rectangular plywood garden container are approximately 1.5-feet tall, 4-feet wide, and 4-feet long, or, alternately, 1.5-feet tall, 4-feet wide, and 8-feet long although the size may vary, as desired. A preferred thickness for the plywood to comprise the sides of the plywood garden container is ⅜ inches but may be ¼ inch, ½ inch, or other thickness as desired. The four plywood sides are positioned upright to create a rectangular shape. Four upright posts are disposed at each corner within the interior space of the plywood garden container. The upright posts preferably include a 2-inch by 2-inch cross-sectional stock. The plywood sides are screwed onto the upright posts to form an enclosed rectangular shape for the plywood garden container.

A sheet of wire mesh (preferably conventional chicken wire) is fashioned to the size of an underside, i.e. the bottom, of the plywood garden container. For example, in the case of a preferred square 4-feet wide by 4-feet long plywood garden container, the wire mesh would be fashioned to 4-feet wide and 4-feet long. The wire mesh is pulled taught and anchored to the inside wall of the plywood garden container proximate to the bottom of the container at a multiplicity of anchor points. Anchors may be fashioned from staples, including U-shaped nails. Alternatively, anchors may be fashioned from eye screws. Anchor points are positioned preferably one per inch or at most one per two inches horizontally along each interior surface of the four sides of a plywood garden container and about two inches from the bottom of the container. Hardware cloth may be used instead of chicken wire to secure the sides of a plywood garden container. Once anchored by a multiplicity of anchor points, the wire mesh provides a novel structural capacity that distributes pressure away from the corners and to all parts of a plywood garden container. Said structural capacity provides the surprising benefit of preserving the shape of plywood sides of a plywood garden container even when plywood sides have been bowed or curved. The wire mesh also provides the added benefit of protection from burrowing animals such as gophers. Furthermore, the wire mesh provides the added benefit of preventing aliasing of a plywood garden container during shipping and handling.

Lightweight corner posts may be used for any embodiment with 90 degree angles including a rectangular shape as described above, L-shapes, U-shapes, and many other desired shapes. Alternatively one or more hinges may be disposed at a corner regardless of the desired angle formed by adjoining sides of a plywood garden container. A hexagon-shaped embodiment including six straight sides and twelve hinges for securing corners is next described. Sides may be any desired size, for example 1.5 feet high, 2.5 feet long, and ⅜ inch thick. Sides are positioned upright to form a pentagon shape for a plywood garden container. One or more hinges, i.e. two in this example, are disposed at each corner to secure adjacent sides in an upright position. Wire mesh is fashioned to the same shape as the bottom of a plywood garden container and anchored to the interior surfaces of the sides proximate the bottom of the container as described above. Other possible shapes for a plywood container garden comprised of straight sides include triangles, stars, or many other desired shapes.

The instant invention not only prevents bowing of straight sides of a plywood garden container but also stabilizes curved (or bowed) sides when desired. Outwardly curved sides (i.e., convex relative to the area outside the container; hereinafter “convex sides”) may be used, for example, to produce oval-shaped plywood garden containers (not shown). In the case of one or more inwardly curved sides (hereinafter “concave sides”) an additional area of wire mesh is disposed on the ground outside of the plywood garden container between the corners adjoining the one or more concave sides. When anchored at a multiplicity of anchor points the wire mesh provides the surprising structural capacity to preserve even a concave side in its original shape as a side of a plywood garden container. A detailed description of a curved plywood garden container with one convex side and one concave side is given below.

A top of the plywood container garden is open to provide access to the interior of the plywood garden container. The bottom is constructed only of the wire mesh, which along with the benefits mentioned above allows fluid to drain out of the plywood garden container. The primary benefit of the wire mesh was the distribution of bowing pressure to all parts of the garden container such that bowing was prevented on straight sides, bowing was preserved on convex and even on concave sides, and the need for strong or reinforced corners was eliminated. A safe and novel use of food-grade paint may extend the life of a plywood garden container to rival or surpass prior art garden containers.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1A is an upper perspective view of a first preferred embodiment of the plywood garden container of the present invention, in this instance comprising a generally square configuration;

FIG. 1B is a top plan view thereof;

FIG. 1C is a partial side view in elevation showing the anchoring schedule on a bottom portion of the interior of a plywood side panel, this view showing the wire mesh implemented in the form of conventional hexagonal chicken wire;

FIG. 2A is an upper perspective view of a second preferred embodiment of the inventive plywood garden container, illustrating how the container can be configured in various complex polyhedral shapes, including that of a hexagon;

FIG. 2B is a top plan view thereof;

FIG. 2C is a partial side view in elevation showing the anchoring schedule on a bottom portion of the interior of a plywood side panel, this view showing the wire mesh implemented in the form of conventional square hardware cloth;

FIG. 3A is an upper front perspective view of a third preferred embodiment of the inventive plywood garden container, in this instance a parallelogram with opposing straight sides and opposing curved (convex and concave) sides;

FIG. 3B is a top plan view thereof;

FIG. 3C is a partial upper front perspective view showing the adjoining convex and flat sides of the third preferred embodiment;

FIG. 3D is a partial upper rear perspective view showing the adjoining concave and flat sides of the third preferred embodiment, as well as the wire mesh anchoring scheduled called for in holding the concave shape of the concave side; and

FIG. 3E is a cross-sectional side view in elevation showing the configuration of the wire mesh as anchored on the interior sides of the garden container and as stretched along the lower edge of the concave side of the container.

### DETAILED DESCRIPTION OF THE INVENTION

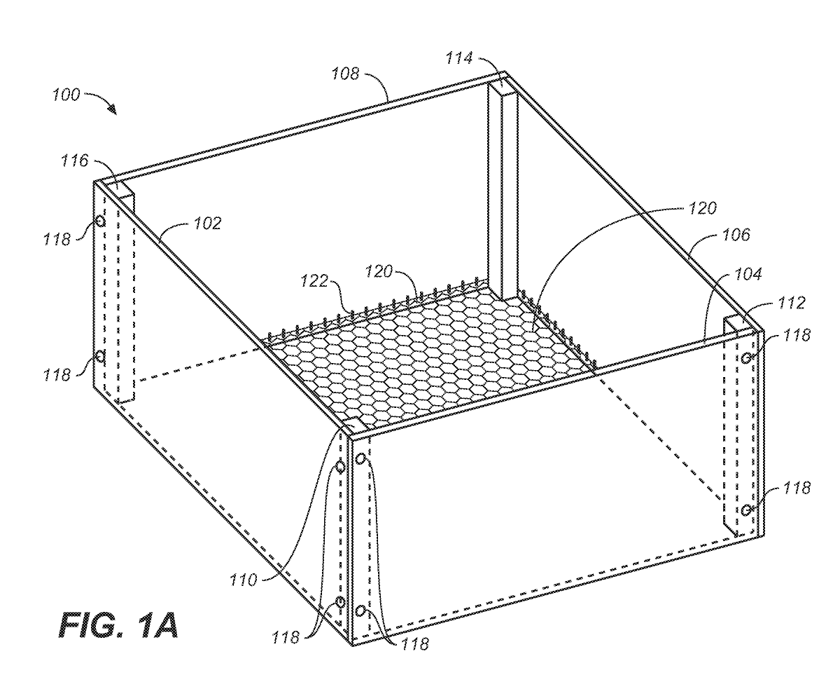

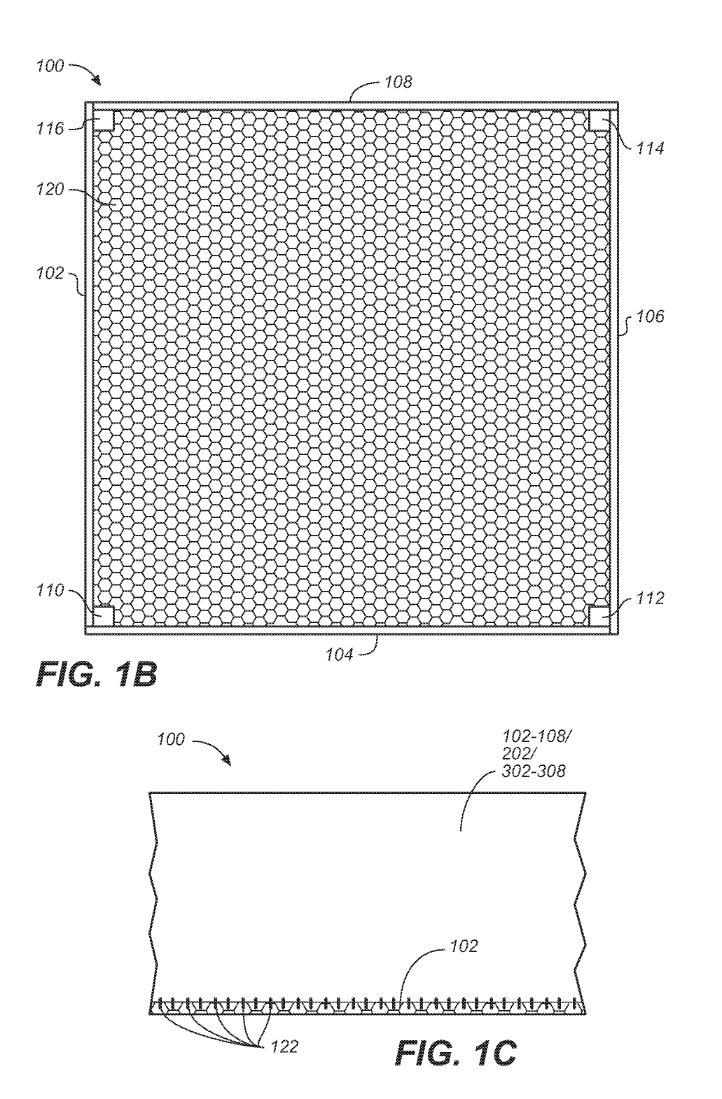

Referring to FIGS. 1-3E, wherein like numbers refer to like elements in the various views, there is shown an improved garden container, namely, a plywood garden container, generally denominated in FIGS. 1A-3 as 100, 200, and 300, respectively.

Referring first to FIG. 1A, there is shown a plywood garden container, generally denominated 100.

The plywood garden container 100 provides a suitable environment for gardening. The plywood garden container 100 is placed directly onto a ground surface, and the interior defined by the container sides is filled with a suitable quantity of soil or another desired planting medium. Seeds or plants are then planted in the growing medium. The plywood container garden 100 provides an improved environment for gardening for many reasons described in detail below.

The plywood container garden 100, as shown in FIGS. 1A and 1B includes first, second, third, and fourth plywood sides 102, 104, 106, and 108, respectively. The four plywood sides form a parallelogram, preferably square, for the plywood container garden 100. Numerous alternative shapes are possible, as described in greater detail hereinafter.

The plywood used to form the first through fourth plywood sides 102-108 is preferably made from thin, untreated plywood. The use of untreated wood is preferred because chemicals used to treat the wood may contaminate soil with toxins. For best balancing the interests of cost, of handling, and of durability, the plywood sides are preferably ⅜-inch thick. Alternatively, plywood may be ¼ inch thick, ½ inch thick or other thickness as desired. Further to the economic, environmental, and social interests motivating the present invention, the plywood used in the present invention is preferably fabricated using trees grown in sustainable forestry programs.

Compared to milled lumber, plywood provides greater dimensional stability, greater strength, greater distribution of strength, resistance to splitting, and resistance to expansion and contraction. Because plywood is made from inexpensive materials, i.e. from a variety of young trees, costs of plywood are generally competitive with or lower than the costs of milled hardwood (i.e., redwood, oak, birch, and locust) planks. When convex or concave sides are part of a desired shape, plywood may be easily fashioned into that desired shape whereas milled lumber hardwood planks are notoriously difficult to bow.

A common problem in the prior art wooden garden containers is that the wood used to form the container sides is prone to rotting even after a short time in use. As plywood is typically made with several layers of wood veneers glued together, the plywood sides 102-108 are relatively durable even when maintained in contact with soil, including wet soil. Nevertheless, all wood used for garden containers rots eventually. The bacteria naturally present within rotting wood can contaminate the soil of the prior art wooden garden containers. Bacteria from the rotting wood compete with beneficial bacteria present in the soil and disrupt the desired ecosystem within the garden thus inhibiting plant growth and causing plant loss.

Besides rotting, prior art hardwood planks are subject to bowing pressure after the container is filled with soil and water. This feature alone contraindicated the use of plywood for container gardening in the minds of consumers and gardeners. The planks and heavy posts used to create prior art wooden garden containers are usually thick enough to provide support against bowing. However dirt and other contents still push against the interior sides of the side boards, which creates extreme pressure at the corners of prior art wooden garden containers. A combination of rot especially around the corners and pressure from the interior of the container causes prior art wooden garden containers to fail in the long term. Thus, the prior art hardwood planks are often reinforced with cross-bracing, metal spikes, numerous vertical posts, and other structures intended to reinforce corner supports and prevent bowing. All of these solutions, unfortunately, simply increase manufacturing and sales cost of the prior art wooden garden containers.

Due to the novel application of the wire mesh 120 used in the inventive plywood container 100, the sides of said container are comprised only of wood, preferably of plywood or alternatively of other wood, typically one-half inch or less in thickness (FIGS. 1A-1B). Therefore the inventive plywood garden container 100 is less expensive to produce compared to prior art garden containers. Furthermore, plywood may be produced in an ecologically sustainable way almost anywhere in the world so the inventive plywood container will benefit the environment.

The plywood sides 102-108 are secured together at their respective corners by four vertical generally upright posts 110, 112, 114, and 116 disposed on the interior of the container to form a generally square-shaped structure in this first preferred embodiment. The joined sides and corner posts thus define the interior of the container. Each plywood side is secured to each of two adjoining upright posts using a plurality of screws or other fasteners 118. The upright posts 110-116 are preferably formed of 2-inch by 2-inch (or alternatively 1-inch by 1-inch) cross-sectional stock, and for a typical container, approximately 16-inches in height. The height of the upright posts 110-116 will obviously vary according to the height of the plywood sides 102-108. A preferred wood for the upright posts 110-116 is pine but any 2-inch by 2-inch cross-sectional stock may be used.

As shown in FIGS. 1A-1B the first plywood side 102 is secured to the first and fourth upright posts 110 and 116 using screws 118. The second plywood side 104 is secured to the first and second upright posts 110 and 112. The third plywood side 106 is secured to the second and third upright posts 112 and 114. The fourth plywood side 108 is secured to the third and fourth upright posts 114 and 116.

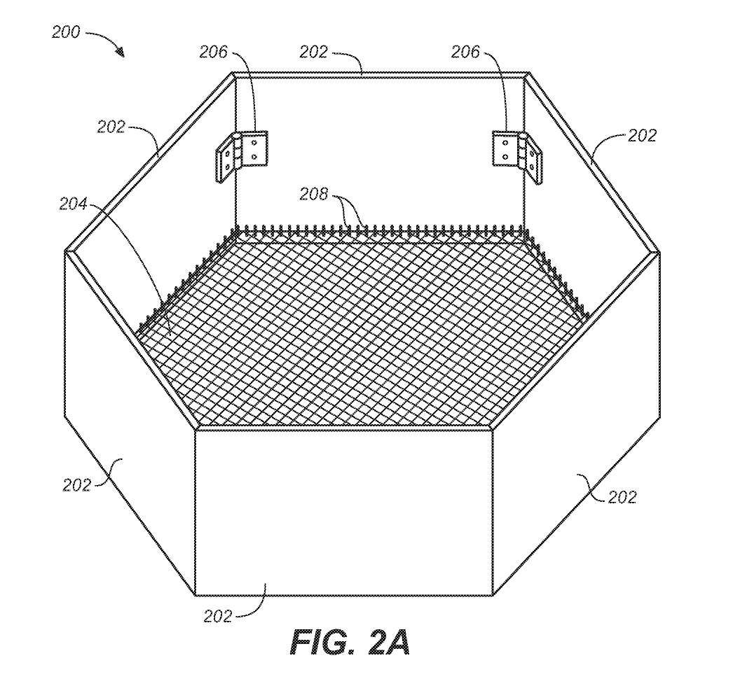

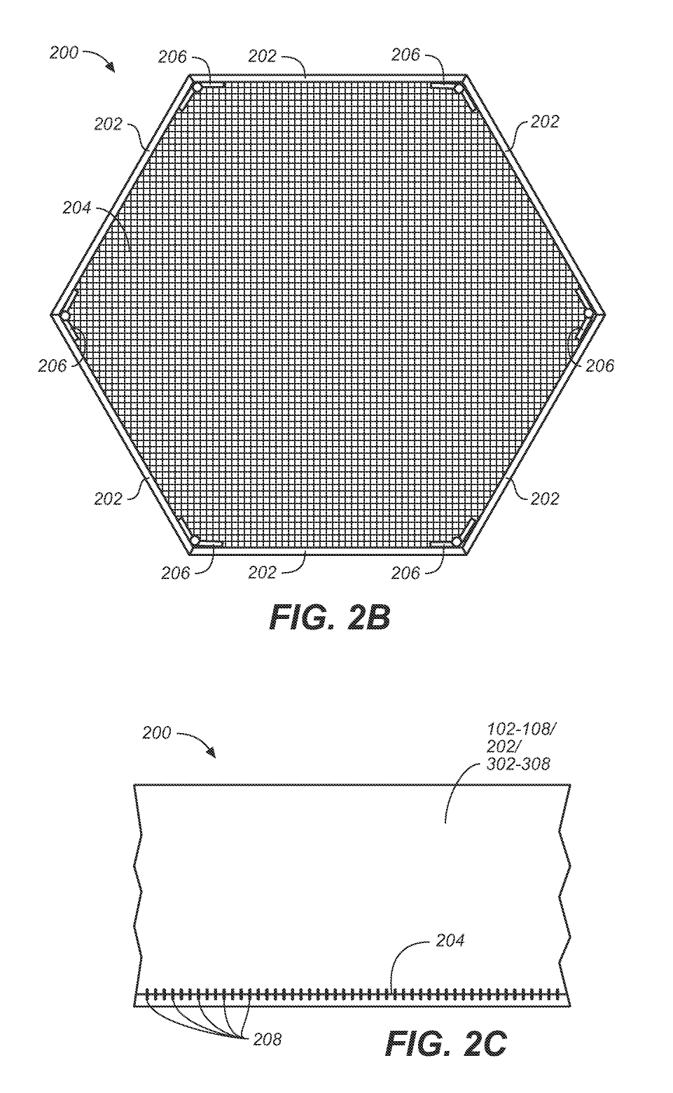

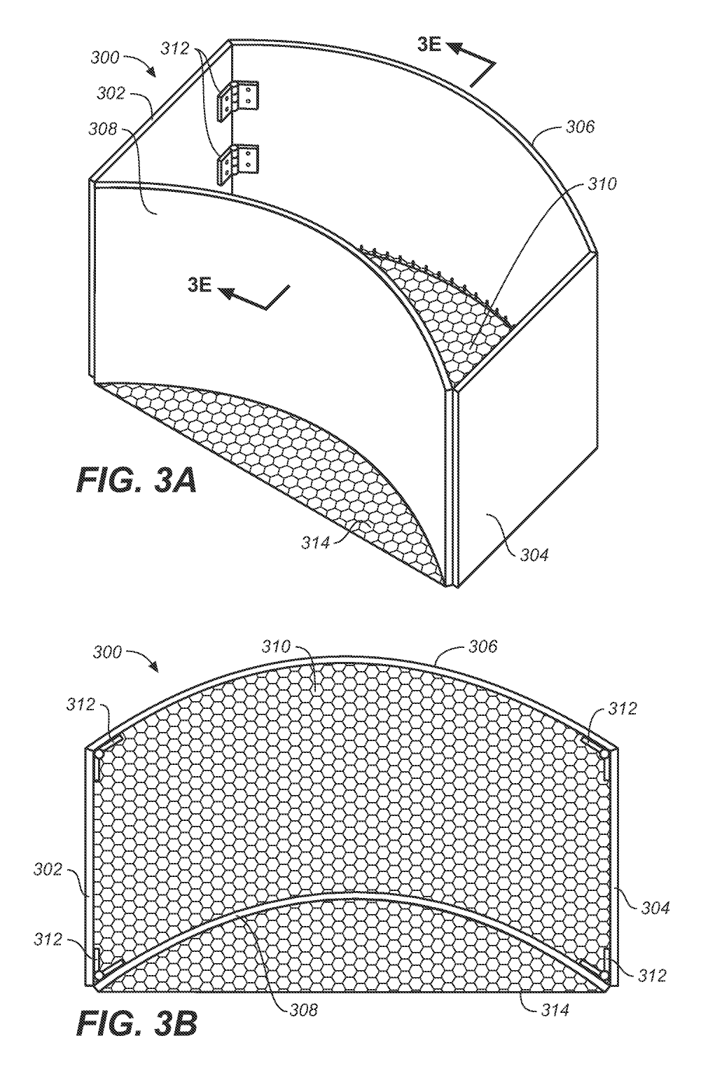

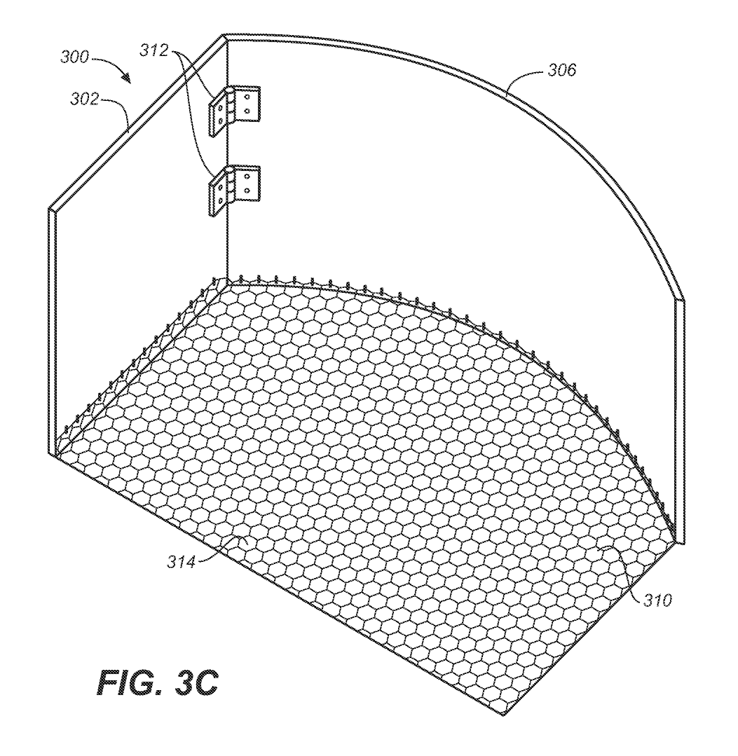

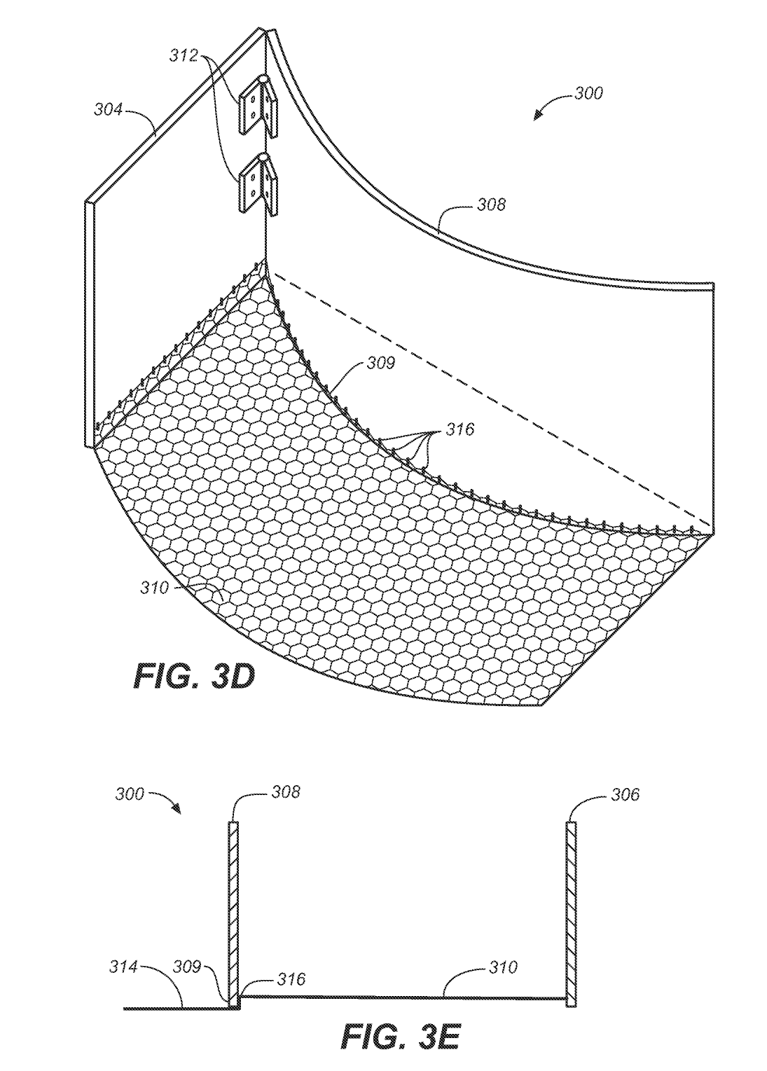

For most residential gardens, the preferred dimensions of the first embodiment of the plywood container garden are 16-inches tall, 4-feet wide, and 4-feet long. A rectangular variation might be 16-inches tall by 4-feet wide by 8-feet long. Alternatively, fruit trees and some vegetables may require taller containers so the plywood garden container may be 2-feet tall, 3-feet wide and 6-feet long. Quite clearly, however, the size and shape variations are myriad (see FIGS. 2A-3D).

A sheet of wire mesh 120, preferably chicken wire, approximately 4-feet by 4-feet in size is stretched and anchored taught along an underside of the plywood garden container. If desired, hardware cloth may be used instead of chicken wire, though the latter is preferred for ease in manufacturing the inventive plywood garden container. In addition chicken wire mesh better meets the structural objectives of certain embodiments especially for example for a plywood garden container with one or more concave sides as described in detail below (FIG. 3). The wire mesh 120 is anchored along the interior of all of the plywood sides 102-108 as close to the bottom edge of the side as structurally practicable for the plywood material used in fabricating the garden container (FIGS. 1A and 1C). Anchors may be industrial staples or U-shaped nails of a length that approximates the thickness of the sides a plywood garden container. Alternatively, anchors may be fashioned from eye screws. The wire mesh is anchored taught along each of its edges using a tight schedule of anchors 122 so as to ensure connections along substantially the entirety of each side and thus also to ensure broadly distributed and even tension across the entire wire mesh.

The wire mesh 120 provides several important and unexpected benefits. Most importantly, the wire mesh provides structural integrity to the inventive plywood container garden. In particular, the wire mesh 120 prevents unwanted outward bowing of the straight plywood sides. Conversely, if one or more convex or concave sides are desired, the wire mesh helps maintain the desired curvature as described below in relation to FIGS. 3A-3D. The wire mesh 120 also helps prevent gophers or other burrowing animals from entering the interior of the plywood container garden when the plywood container garden is placed directly on the ground. Another benefit is that the wire mesh 120 facilitates the rapid drainage of water from the container, thus reducing the time that water is in contact with the side panels. Another important benefit is that the wire mesh prevents aliasing of the sides 102-108 during shipping.

In addition to the foregoing benefits of the wire mesh, the use of a food grade paint to paint the wooden parts used in fashioning the inventive plywood garden container added several significant benefits. A first benefit of the food-grade paint used to paint the wooden parts of the inventive plywood garden container was the prevention of rot in the wooden parts of said container, after the planting of a garden in said container. A second related benefit of the food-grade paint was to help control the bacterial fauna of the soil after soil was placed in the interior of the inventive plywood garden container. A third benefit of the food-grade paint was to prevent plywood sides from soaking up water allowing for better control of the chemical environment on the interior of the inventive plywood garden container. A fourth benefit of the food-grade paint was to improve the aesthetics of the inventive plywood garden container. Finally and most importantly, all of these benefits were added safely simply because the paint was food grade.

Referring next to FIGS. 2A-2B, there is shown a second preferred embodiment 200 of the inventive plywood container garden. In this embodiment, the plywood container garden is configured into a hexagon shape as viewed from above or below. The second preferred embodiment of the plywood garden container includes an enclosed container 200 formed with 6 plywood sides 202 of identical length from which to configure a hexagon. This embodiment is identical in all material respects with that of the first preferred embodiment, save for the extra two sides, the shape of the wire mesh 204, the pattern of the wire mesh, and the fact that the corners are secured using internal hinges 206 rather than posts.

The second modified plywood container garden 200 includes a wire mesh 204 fashioned to the same shape as said container itself and disposed along an underside, thereof. The wire mesh 204 is stretched taught and anchored along each of its edges, with staples or U-shaped nails 210 preferably placed in a schedule of one staple per square opening. The line of anchors 208 thus circumscribes the interior closely proximate the bottom of a plywood garden container 200.

As will be appreciated, in this second preferred embodiment 200 as with the first preferred embodiment, by using hinges 206 at the corners, the container may be shaped before placement of the wire mesh 204 by adjusting each set of hinges 206 to the proper angle, thus making the container a hexagon 200. When configured as desired, the wire mesh 204 can be anchored to the sides and the shape fixed.

Referring next to FIGS. 3A-3C, in a third preferred embodiment of the plywood container garden of the present invention 300, a parallelogram with two straight sides 302, 304, and two opposing curved sides, one convex 306, and one concave 308, is provided. This embodiment is identical in all material respects with that of the first preferred embodiment, save for the two curved sides 306, 308, the shape of the wire mesh 310 and the fact that the corners are secured using internal hinges 312 rather than posts. In this third preferred embodiment, as with the second preferred embodiment, the container 300 may be shaped before placement of the wire mesh 310 by adjusting each set of hinges 312 appropriately.

As apparent in FIGS. 3A-3C the shape of the wire mesh 310 used for the inventive plywood garden container 300 will vary slightly from the shape of said container when said container is comprised of one or more concave sides. In order to help preserve the shape of the concave side 308, an area of wire mesh 314, comprising the area between two corners of said concave side and the edge of the concave side, is disposed along an outside bottom of the container and in a line between the two corners of the concave side. When configured as desired, the wire mesh can be secured with anchors 316 to the interior sides proximate the bottom of the inventive plywood garden container. This placement includes a line of anchors along the interior of concave side 308, such that the wire mesh 310 is stretched along the bottom edge 309 of side 308 (see FIGS. 3D and 3E), so as to provide still further structural support to maintain the concave shape of side 308. As with the other embodiments, placement of the wire mesh in this manner fixes the shape of the container. Although only one set of anchors is necessary, the wire mesh 310 inside the third embodiment, the anchors and mesh along the interior side of concave side 308, and the wire mesh 314 extending outside the concave side act independently but additively for structural support. In addition to the normal outward bowing pressure that occurs when a garden has been planted in the inventive garden container, there is a natural tendency for a bowed board to straighten or flatten. The interior anchors on side 308 and the wire mesh 314 on the outside of a concave side of the inventive plywood garden container helps to prevent this latter problem, as well as adding more resistance to the normal outward bowing pressure.

Curved and straight sides can be combined in any number of ways. It will be appreciated that the inventive plywood garden container can be configured to almost any desired shape. Additionally, the use of bender board, wiggle board, or the equivalent is contemplated for plywood garden containers having significantly curved sides.

The benefits as mentioned herein for the plywood garden container are provided with any of the embodiments. The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

1. A plywood garden container, comprising:
one or more plywood sides having lower edges and configured to form an enclosure with an interior space and to define an interior region between said lower edges of said one or more plywood sides; and
a section of wire mesh anchored along or proximate a bottom region of said enclosure so as to preserve the shape of said enclosure when said enclosure is all or partially filled with a growing medium for gardening.

2. The plywood garden container of claim 1, wherein said plywood garden container includes four plywood sides, and further including means for securing said at least four plywood sides having an upright post disposed at each corner of said enclosure.

3. The plywood garden container of claim 1, wherein said means for securing said at least one or more plywood sides includes one or more hinges disposed at each corner of said enclosure.

4. The plywood garden container of claim 1, wherein some or all wooden parts of said enclosure are painted with one or more coats of food-grade paint.

5. The plywood garden container of claim 4, wherein said one or more plywood sides are painted with one or more coats of food-grade paint.

6. The plywood garden container of claim 1, wherein said enclosure includes a shape which, as viewed from above or below, is selected from the group consisting of a square, a hexagon, and a rhomboid with two opposing curved sides.

7. A plywood garden container, comprising:
A plurality of plywood sides disposed in a substantially vertical orientation, each of said plywood sides having a lower edge, said plywood sides configured to form an enclosure with an interior space for containing a growing medium, and said lower edges defining an interior region; and
wire mesh disposed within said interior region and fastened to said plywood sides in such a way as to substantially fix the shape of said enclosure when said enclosure is all or partially filled with a growing medium for gardening.

8. The garden container of claim 7, wherein said wire mesh preserves the shape of said lower edges of said plywood sides when said enclosure is all or partially filled with a growing medium.
